(19) United States
(12) Patent Application Publication
(10) Pub. No.: US 2014/0059272 A1
(43) Pub. Date: Feb. 27, 2014

(54) DATA PROCESSING SYSTEM AND METHOD FOR STORAGE

(71) Applicants: HONG FU JIN PRECISION INDUSTRY (ShenZhen) CO., LTD., (US); HON HAI PRECISION INDUSTRY CO., LTD., New Taipei (TW)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/728,981

(22) Filed: Dec. 27, 2012

(30) Foreign Application Priority Data
Aug. 27, 2012 (CN) 2012103066957

(51) Int. Cl. G06F 12/02

(52) U.S. Cl. CPC G06F 12/0246
USPC 711/103

(57) ABSTRACT

A data processing system includes a first storage, a second storage, a processor and a controller. The first storage is a non-volatile storage, the second storage is a volatile storage. The first storage and the second storage are initialized when the data processing system is started up. The controller detects whether the first storage and the second storage have been initialized, and generates a signal to control the processor to write data from the first storage to the second storage. The controller further detects when the processor generates a request to read data from the first storage, and generates a reading instruction to control the processor to, instead, read the same data from the second storage that was copied from the first storage to the second storage.

### BACKGROUND

1. Technical Field

The present disclosure relates to data processing systems and methods, more particularly to data processing system and method for storage of data.

2. Description of Related Art

Computer data storages include volatile and non-volatile storages. Computer data for long-term storage can be stored in a non-volatile storage, such as in an EEPROM. However, a speed of the computer system reading the data from or writing the data to the EEPROM is slow. When the amount of data stored in the EEPROM becomes very large, the computer system wastes a lot of time reading and writing the data.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is block diagram of function modules of a data processing system for a storage.

FIG. 2 is a flow chart of a data processing method for a storage in accordance with a first embodiment.

FIG. 3 is a flow chart of a data processing method for a storage in accordance with a second embodiment.

### DETAILED DESCRIPTION

Valuable computer data may be stored in a non-volatile storage, however the speed of a computer system for reading data from or writing data to the non-volatile storage is slow. A processing system and method are provided to improve reading and writing speeds in relation to the non-volatile storage.

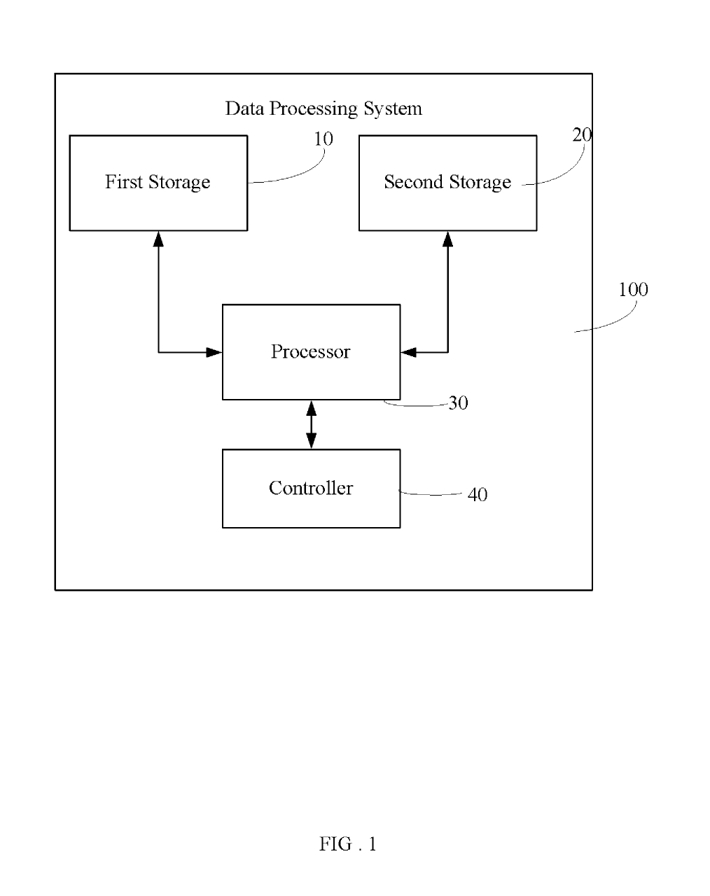

Referring to FIG. 1, the data processing system 100 includes a first storage 10, a second storage 20, a processor 30 and a controller 40. In this embodiment, the first storage 10 is a non-volatile storage, such as an EEPROM. The data of the first storage 10 may include frequently accessed data and infrequently accessed data. The frequently accessed data is accessed very often, other data is seldom accessed. The second storage 20 is a volatile storage, such as an SDRAM. The first storage 10 and the second storage 20 are initialized when the data processing system 100 is started up. The processor 30 reads data from and writes data to both the first storage 10 and the second storage 20. The speed of processor 30 in accessing the first storage 10 is slower than the speed of processor 30 in accessing the second storage 20.

The controller 40 detects whether the first storage 10 and the second storage 20 are initialized, and the controller 40 controls the processor 30 to write data from the first storage 10 to the second storage 20. The processor 30 may write all the data of the first storage 10 to the second storage 20 or write merely the frequently accessed data to the second storage 20.

As an example of a first embodiment, if the processor 30 is to write all the data of the first storage 10 to the second storage 20, then after the first storage 10 and the second storage 20 have been initialized, the controller 40 detects whether the processor 30 generates a reading or a writing request for reading data from or writing data to the first storage 10. The controller 40 sends a reading or a first writing instruction to the processor 30 when such a reading or a writing request is generated. The processor 30 reads corresponding data, from the second storage 20 in response to the reading instruction. The processor 30 further writes corresponding data to the second storage 20 in response to the writing instruction, and the processor 30 generates a detecting signal after the corresponding data has been written to the second storage 20. The controller 40 further detects whether the processor 30 is again idle in response to the detecting signal, and generates a second writing instruction to control the processor 30 to write the written data from the second storage 20 to the first storage 10.

As an example of a second embodiment, if the processor 30 is to write only the frequently accessed data of the first storage 10 to the second storage 20 after the first storage 10 and the second storage 20 are initialized, the controller 40 detects whether the processor 30 generates a reading or a writing request for reading data from or writing data to the first storage 10. The controller 40 detects whether the data requested to read is the frequently accessed data when the reading request is generated. The controller 40 generates a first reading instruction when the corresponding data requested to be read from the first storage 10 is frequently accessed data. The controller 40 generates a second reading instruction if the corresponding data requested to be read from the first storage 10 is infrequently accessed data. The processor 30 reads the frequently accessed data from the second storage 20 in response to the first reading instruction. The processor 30 reads the corresponding infrequently accessed data from the first storage 10 in response to the second reading instruction. The controller 40 further generates a first writing instruction when the writing request is generated. The processor 30 writes corresponding data requested to be written to the second storage 20 in response to the first writing instruction and the processor 30 generates a detecting signal after the corresponding data has been written to the second storage 20. The controller 40 further detects whether the processor 30 is again idle in response to the detecting signal. The controller 40 generates a second writing instruction to control the process 30 to write the corresponding data from the second storage 20 to the first storage 10.

A data processing method for execution by a data processing system. The data processing system includes a first storage, a second storage, and a processor. In this embodiment, the first storage is a non-volatile storage, such as an EEPROM. The second storage is a volatile storage, such as an SDRAM. The first storage and the second storage are initialized when the data process system is started up. The processor can read and write data from and to both the first storage and the second storage. The speed of a processor in accessing the first storage is slower than the speed of processor in accessing the second storage.

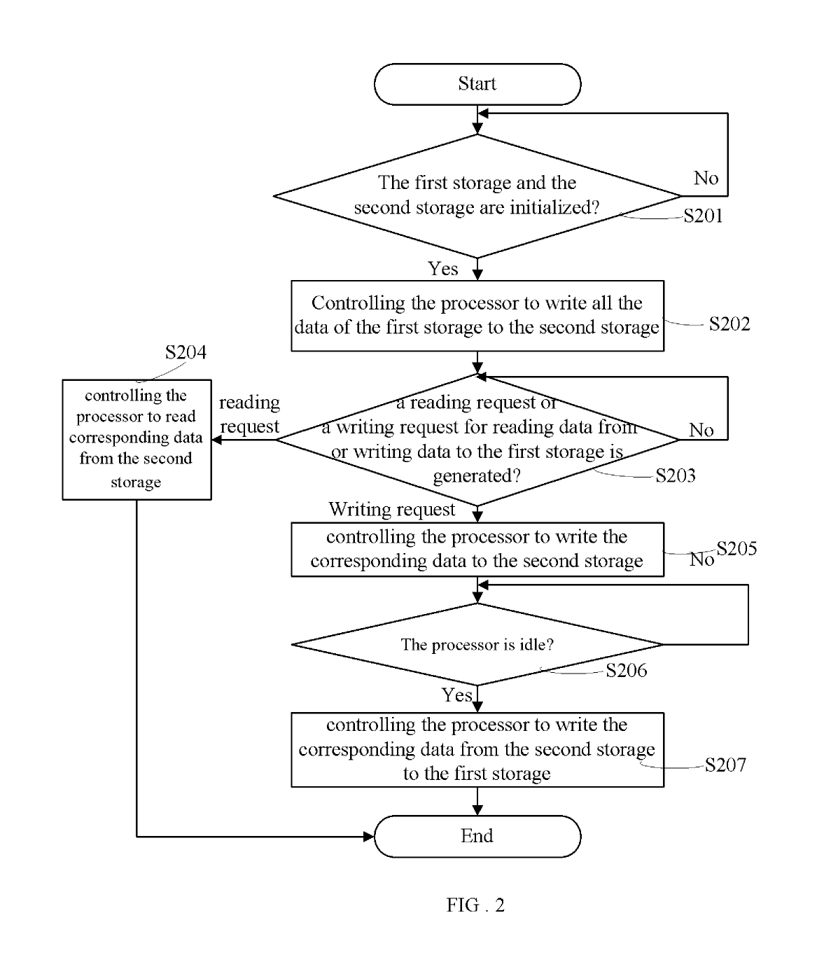

Referring to FIG. 2, the data processing method in accordance with a first embodiment includes the following steps:

In step S201, detecting whether the first storage and the second storage have been initialized. If the first storage and the second storage have been initialized the process goes to step S202. If the first storage and the second storage are not initialized, repeating step S201.

In step S202, controlling the processor to write all the data of the first storage to the second storage by the processor.

In step S203, detecting whether a reading request or a writing request for reading data from or writing data to the first storage is generated. If the reading request is generated, the process goes to the step S204. If the writing request is generated, the process goes to the step S205. If the writing request and the reading request are not generated, the process repeats step S203.

In step S204, controlling the processor to read corresponding data from the second storage.

In step S205, controlling the processor to write the corresponding data to the second storage.

In step S206, detecting whether the processor is idle. If the processor is idle, the process goes to step S207. If the processor is not idle, repeating step S206.

In step S207, controlling the processor to write the corresponding data from the second storage to the first storage.

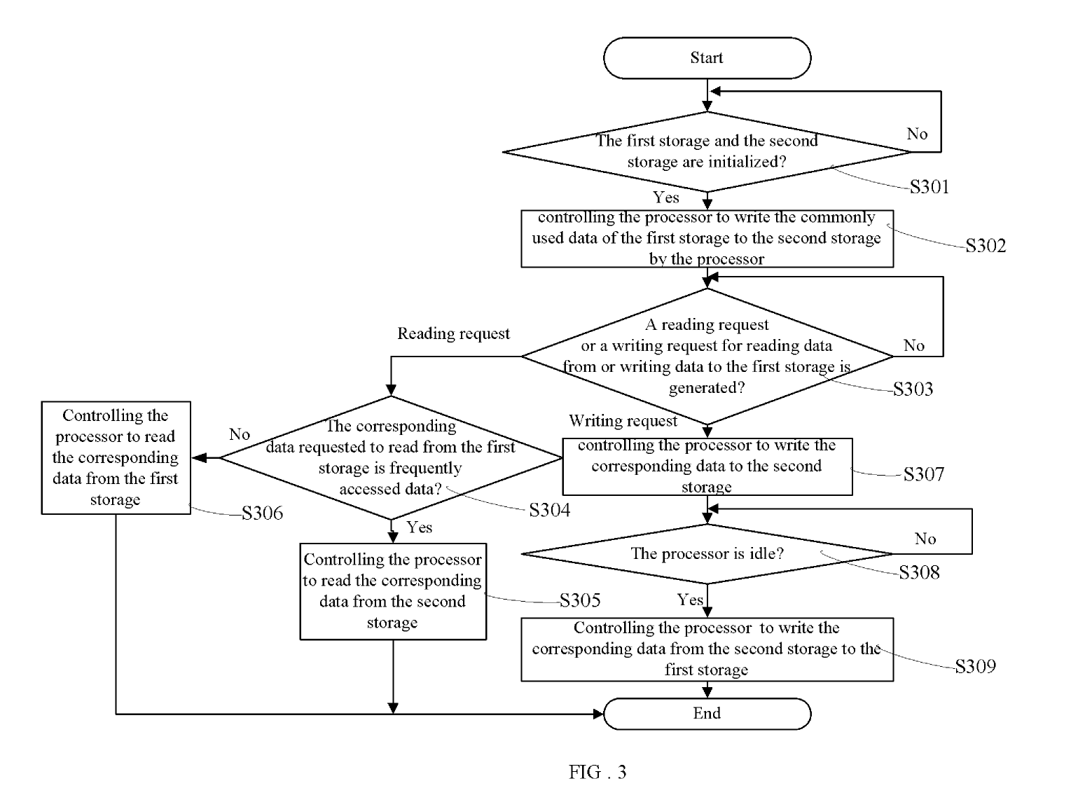

Referring to FIG. 3, a data processing method in accordance with a second embodiment includes the following steps:

In step 301, detecting whether the first storage and the second storage have been initialized. If the first storage and the second storage have been initialized the process goes to step S302. If the first storage and the second storage are not initialized, repeating step S301

In step S302, controlling the processor to write the frequently accessed data of the first storage to the second storage.

In step S303, detecting whether a reading request or a writing request for reading data from or writing data to the first storage is generated. If such a reading request is generated, the process goes to the step S304. If such a writing request is generated, the process goes to the step S307. If such a writing request and the reading request is not generated, repeating step S303.

In step S304, detecting whether corresponding data requested reading from the first storage is frequently accessed data. If the corresponding data is frequently accessed data, the process goes to the step S305, if the corresponding data is not the frequently accessed data, the process goes to the step S306.

In step S305, controlling the processor to read the corresponding data from the second storage.

In step S306, controlling the processor to read the corresponding data from the first storage.

In step S307, controlling the processor to write the corresponding data to the second storage.

In step S308, detecting whether the processor is idle. If the processor is idle, the process goes to step S309. If the processor is not idle, repeating step S308.

In step S309, controlling the processor to write the corresponding data from the second storage to the first storage.

As described above, the processor can write the data of the slow first storage to the faster second storage. The first storage being a slow and non-volatile storage, the speed of the processor in reading data from the second storage is quicker than the speed of the processor in reading data from the first storage, a lot of time can thus be saved in accessing the data of the first storage when placed in the second storage. Further, when the processor is to write data to the first storage, the process firstly writes data to the second storage, and then writes the same data to the first storage, when the processor is idle. Therefore, the writing of data to the first storage does not affect the performing speed of the processor in processing other tasks.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A data processing system, comprising:
a first non-volatile storage;
a second volatile storage, the first storage and the second storage being initialized when the data processing system is started up;
a processor for reading data from or writing data to the first storage and the second storage, the speed of the processor in reading data from and writing data to the first storage is slower than the speed of the processor when reading data from and writing data to the second storage; and
a controller detecting whether the first storage and the second storage have been initialized, and generating a detecting signal to control the processor to write data of the first storage to the second storage when the first storage and the second storage have been initialized; the controller further detecting whether the processor generates a reading request for reading data of the first storage, and generating a reading instruction to control the processor to read corresponding copied data from the second storage when the processor generates the reading request.

2. The data processing system of claim 1, wherein the controller controls the processor to write all the data of the first storage to the second storage when the first and the second storages have been initialized.

3. The data processing system of claim 1, wherein the data of the first storage comprises frequently accessed data and infrequently accessed data, the controller controls the processor to write the frequently accessed data of the first storage to the second storage when the first and the second storages have been initialized, the controller detects whether the corresponding data requested reading from the first storage is the frequently accessed data when the reading request is generated, the controller generates the reading instruction to control the processor to read the corresponding copied data from the second storage when the corresponding data is the frequently accessed data.

4. The data processing system of claim 1, wherein the controller further detects whether the processor generates a writing request for writing data to the first storage, and generates a first writing instruction to control the processor to write data to the second storage when the writing request is generated, the controller further detects whether the processor is idle, and generates a second writing instruction to control the processor to write the written data from the second storage to the first storage when the processor is idle.

5. The data processing system of claim 1, wherein the first storage is an EEPROM, the second storage is a SDRAM.

6. A data processing method, executed by a data processing system, the data processing system comprising a first non-volatile storage, a second volatile storage, and a processor, the first storage and the second storage being initialized when the data processing system is started up, the processor reading data from and write data to the first storage and the second storage, the speed of the processor in reading data from and writing data to the first storage being slower than the speed of the processor when reading data from and writing data to the second storage, the data processing method comprising steps of:
detecting whether the first storage and the second storage have been initialized;
controlling the processor to write the data of the first storage to the second storage;
detecting whether a reading request for reading data from the first storage is generated; and
controlling the processor to read corresponding copied data from the second storage when the reading request is generated.

7. The data processing method of claim 6, wherein the controller controls the processor to write all the data of the first storage to the second storage when the first and the second storages have been initialized.

8. The data processing method of claim 6, wherein the data of the first storage includes frequently accessed data and not frequently accessed data, the controller controls the processor to write all the data of the first storage to the second storage when the first and the second storages have been initialized.

9. The data processing method of claim 8, wherein before the step of reading the corresponding from the second storage, the data processing method further comprises the steps of:
determining whether the corresponding data requested reading from the first storage is frequently accessed data; and
controlling the processor to read the corresponding copied data from the second storage when the corresponding data requested to read is the frequently accessed data.

10. The data processing method of claim 8, wherein controlling the processor to read the corresponding data requested to read, from the first storage when corresponding data is not frequently accessed data.

11. The data processing method of claim 6, wherein the data processing method further comprises steps of:
detecting whether the processor generates a writing request for writing data to the first storage;
controlling the processor to write the corresponding data to the second storage when the writing request is generated;
detecting whether the processor is idle;
controlling the processor to write the corresponding data to the first storage from the second storage when the processor is idle.
